(19) United States
(12) Patent Application Publication
(10) Pub. No.: US 2010/0290688 A1
(43) Pub. Date: Nov. 18, 2010

(54) SLICE DETERMINATION APPARATUS, MAGNETIC RESONANCE IMAGING SYSTEM, AND SLICE SETTING METHOD

(76) Inventor: Takao Goto, Tokyo (JP)

Correspondence Address: PATRICK W. RASCHE (20459);ARMSTRONG TEASDALE LLP, 7700 Forsyth Boulevard, Suite 1800, St. Louis, MO, 63105, US

(21) Appl. No.: 12/781,519

(22) Filed: May 17, 2010

(30) Foreign Application Priority Data
May 18, 2009 (JP) 2009-119396

(51) Int. Cl. G06K 9/00

(52) U.S. Cl. 382/131

(57) ABSTRACT

A slice determination apparatus includes a feature point setting unit for setting a plurality of feature points to a subject, a reference axis determination unit for determining a reference axis, based on the feature points, and a slice setting unit for setting a plurality of slices, based on the reference axis.

### CROSS REFERENCE TO RELATED APPLICATIONS

This application claims the benefit of Japanese Patent Application No. 2009-119396 filed May 18, 2009, which is hereby incorporated by reference in its entirety.

### BACKGROUND OF THE INVENTION

Embodiments described herein relate to a slice determination apparatus, a magnetic resonance imaging system, a slice setting method and a program used for setting slices to a subject.

When the head of a subject is imaged by a magnetic resonance imaging system, it is necessary to set slices to the head thereof. A method for automatically setting slices has recently been proposed to make it possible to set the slices in a short time (refer to Itti L., Chang L., Mangin J. F., Darcourt J. and Ernst T., “Robust multimodality registration for brain mapping”, Human Brain Map, vol. 5, pp. 3-17, 1997). As the method for automatically set the slices, there has been known a method for setting each slice to a standard brain in advance, matching a brain extracted from image data of a subject with the standard brain and inverse-transforming each slice set to the standard brain to the extracted brain.

Brains have various shapes depending on subjects. Thus, a problem arises in that when each slice set to a standard brain is inverse-transformed to an extracted brain, each slice can be set to a desired position with respect to a brain of a given subject, whereas each slice is greatly shifted from a desired position with respect to a brain of another subject.

It is desirable that the problem described previously is solved.

### BRIEF DESCRIPTION OF THE INVENTION

A slice determination apparatus of the invention includes: a feature point setting unit for setting a plurality of feature points to a subject; a reference axis determination unit for determining a reference axis, based on the feature points; and a slice setting unit for setting a plurality of slices, based on the reference axis.

A slice determining method of the invention includes: a feature point setting step for setting a plurality of feature points to a subject; a reference axis determining step for determining a reference axis, based on the feature points; and a slice setting step for setting a plurality of slices, based on the reference axis.

A program of the invention is a program for causing a computer to execute: a feature point setting process for setting a plurality of feature points to a subject; a reference axis determining process for determining a reference axis, based on the feature points; and a slice setting process for setting a plurality of slices, based on the reference axis.

In the invention, a reference axis is determined based on a plurality of feature points set to a subject, and a plurality of slices are set based on the reference axis. It is thus possible to set each slice so as not to be shifted greatly from a desired position.

Further objects and advantages of the present invention will be apparent from the following description of the preferred embodiments of the invention as illustrated in the accompanying drawings.

### BRIEF DESCRIPTION OF THE DRAWINGS

FIG. 1 is a schematic diagram of a magnetic resonance imaging system 1 according to a first embodiment of the invention.

FIG. 2 is a diagram showing one example of an operation flow of the MRI system 1.

FIG. 3 is a diagram schematically illustrating a reconstructed three-dimensional image DV of subject.

FIG. 4 is a sagittal image of a head 8a at a median plane thereof.

FIG. 5 is one example illustrating an image in which contours of a corpus callosum 8d and a brain stem 8e have been enhanced.

FIGS. 6A, 6B, and 6C are diagrams schematically showing three contour models.

FIGS. 7A and 7B are diagrams showing the manner of a contour model M1 prior to affine transformation thereof with respect to the corpus callosum 8d in the differential image Id and the manner thereof subsequent to its affine transformation.

FIGS. 8A and 8B are diagrams depicting the manner of the contour model M1 subsequent to its affine transformation, prior to its deformation based on a front end F of the corpus callosum 8d and the manner thereof subsequent to its deformation.

FIG. 9 is a diagram showing the manner of both the corpus callosum 8d and the brain stem 8e after modeling of an outline OT of a caudal end B of the corpus callosum 8d and modeling of an outline OP of an upper portion U of the brain stem 8e are performed.

FIG. 10 is a diagram showing the relationship of positions between a sagittal image (see FIG. 4) and three feature points P12, P23 and P33.

FIG. 11 is a diagram showing one example of set reference axes.

FIGS. 12A and 12B are diagrams for describing a method of setting a reference slice Sr.

FIG. 13 is a diagram showing one example of set slices.

FIG. 14 is a diagram illustrating feature points P12, P23 and Q1 set in a second embodiment.

FIG. 15 is a diagram showing one example of set reference axes.

FIGS. 16A and 16B are diagrams for describing a method of setting a reference slice Sr′.

FIG. 17 is a diagram showing one example of set slices.

### DETAILED DESCRIPTION OF THE INVENTION

Although preferred embodiments of the invention will be explained below, the invention is not limited to the following embodiments.

### (1) First Embodiment

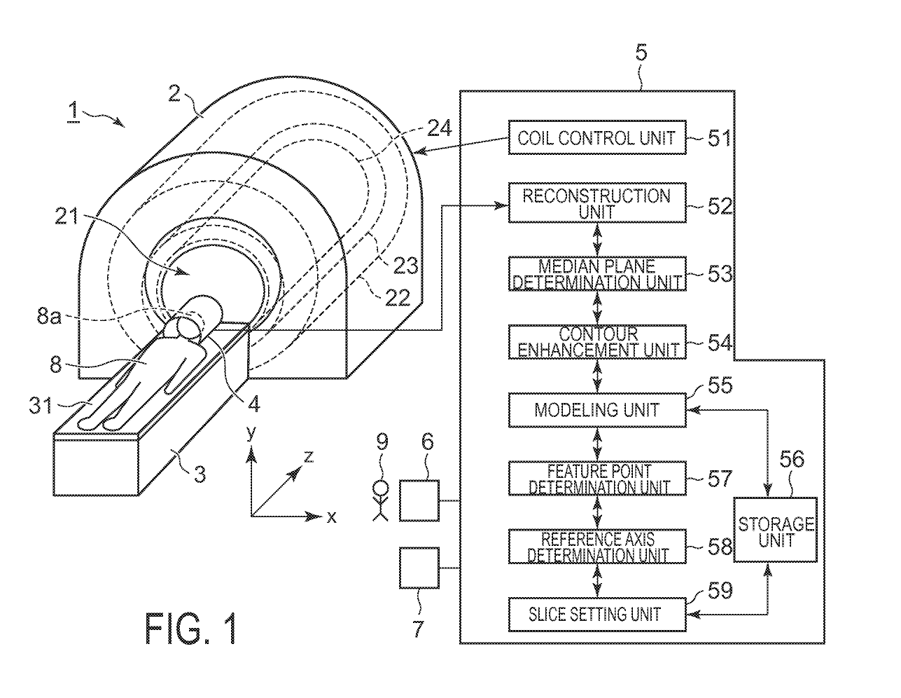

FIG. 1 is a schematic diagram of a magnetic resonance imaging system 1 according to a first embodiment of the invention.

The magnetic resonance imaging system (hereinafter called “MRI (Magnetic Resonance Imaging)” system) 1 has a coil assembly 2, a table 3, a receiving coil 4, a controller 5, an input device 6 and a display device 7.

The coil assembly 2 has a bore 21 in which a subject 8 is held, a superconductive coil 22, a gradient coil 23 and a transmitting coil 24. The superconductive coil 22 applies a static magnetic field B0, the gradient coil 23 applies a gradient pulse and the transmitting coil 24 transmits an RF pulse.

The table 3 has a cradle 31. The cradle 31 is configured so as to move in a z direction and a −z direction. With the movement of the cradle 31 in the z direction, the subject 8 is conveyed to the bore 21. With the movement of the cradle 31 in the −z direction, the subject 8 conveyed to the bore 21 is carried out of the bore 21.

The receiving coil 4 is attached to the head 8a of the subject 8. An MR (Magnetic Resonance) signal received by the receiving coil 4 is transmitted to the controller 5.

The controller 5 has a coil control unit 51, a reconstruction unit 52, a median plane determination unit 53, a contour enhancement unit 54, a modeling unit 55, a storage unit 56, a feature point setting unit 57, a reference axis setting unit 58, and a slice setting unit 59.

The coil control unit 51 controls the gradient coil 23 and the transmitting coil 24 in such a manner that a pulse sequence is executed.

The reconstruction unit 52 reconstructs an image, based on the MR (Magnetic Resonance) signal received by the receiving coil 4.

The median plane determination unit 53 determines a median plane, based on the reconstructed image.

The contour enhancement unit 54 enhances the contour of a predetermined portion or region in the image reconstructed by the image reconstruction unit 52.

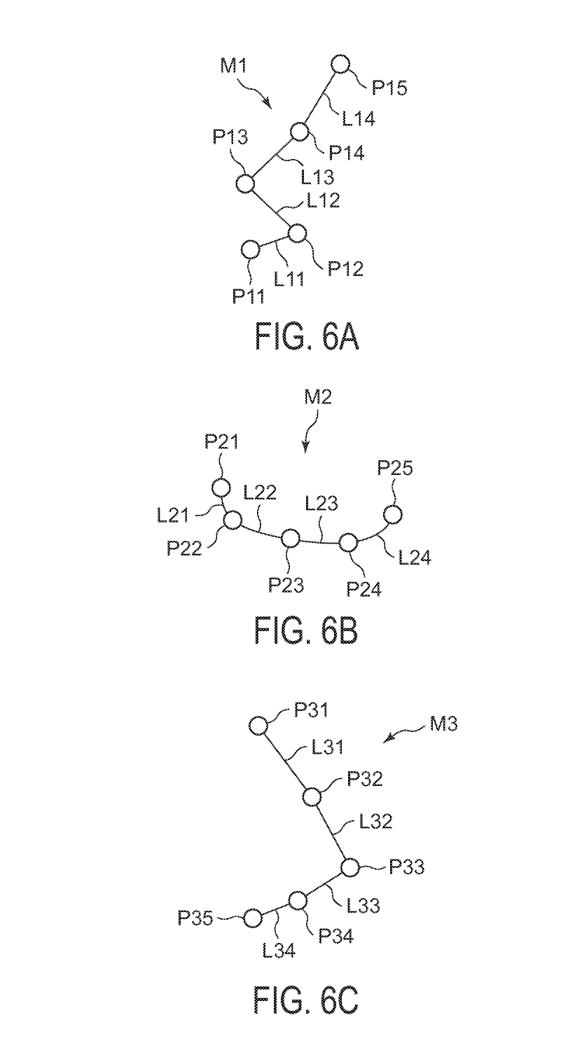

The modeling unit 55 models the contours of predetermined regions, based on contour models M1, M2 and M3 (see FIGS. 6A-6C) stored in the storage unit.

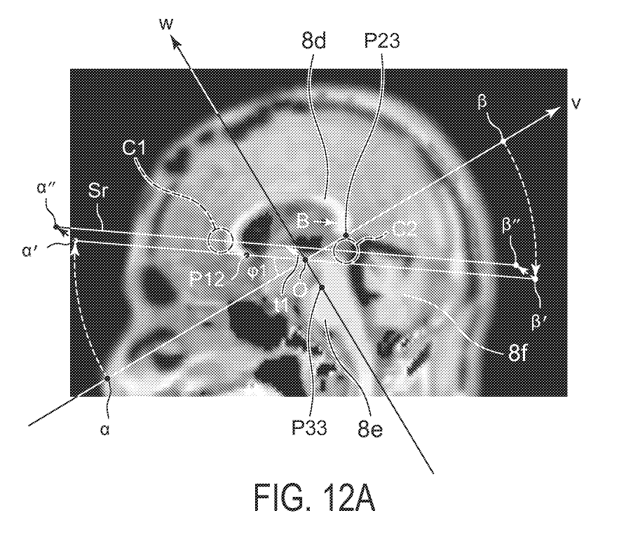

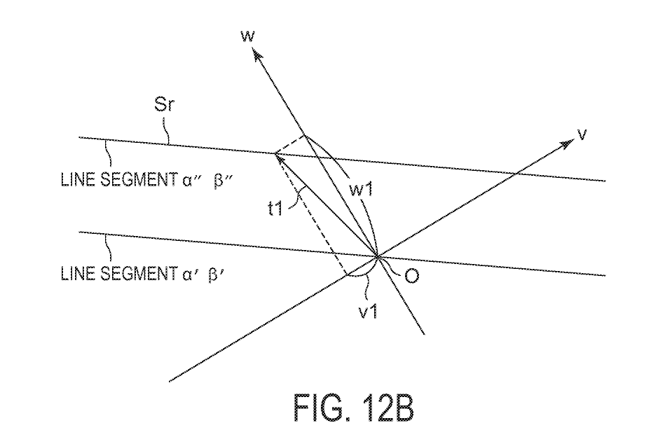

The storage unit 56 stores the contour models M1, M2 and M3, a rotational angle Φ=φ1 and the value of an offset T=t1 (see FIGS. 12A and 12B) therein. The storage unit 56 is of, for example, a hard disk or a removal disk.

The feature point setting unit 57 sets feature points to the modeled contours of predetermined regions.

The reference axis setting unit 58 determines each reference axis, based on the feature points set by the feature point setting unit 57.

The slice setting unit 59 sets slices, based on the reference axis set by the reference axis setting unit 58.

Incidentally, the coil control unit 51, the reconstruction unit 52, the median plane determination unit 53, the contour enhancement unit 54, the modeling unit 55, the storage unit 56, the feature point setting unit 57, the reference axis setting unit 58, and the slice setting unit 59 are realized by installing programs for executing the respective units in the controller 5. They may however be realized only by hardware without using the programs.

The input device 6 inputs various instructions to the controller 5 in response to operations of an operator 9.

The display device 7 displays various information thereon.

The MRI system 1 is configured as described above. The operation of the MRI system 1 will next be explained.

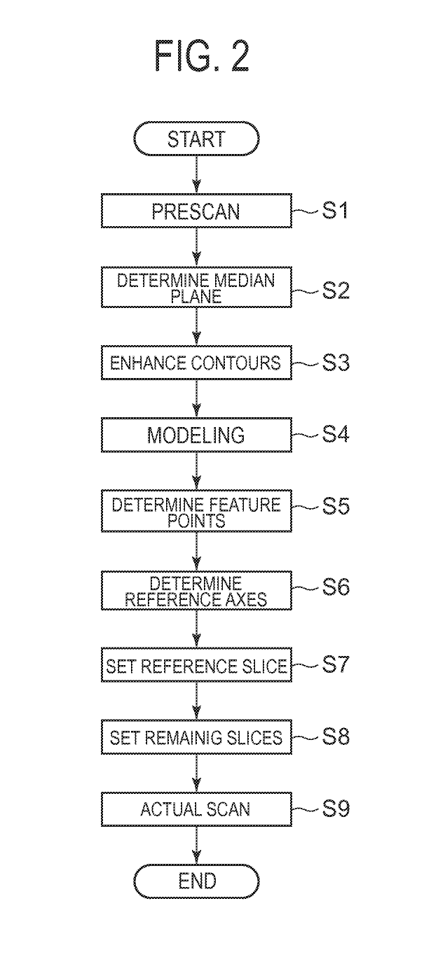

FIG. 2 is a diagram showing one example of an operation flow of the MRI system 1.

At Step S1, the operator 9 operates the input device 6 to input a prescan imaging command to the controller 5. The coil control unit 51 of the controller 5 (see FIG. 1) controls the gradient coil 23 and the transmitting coil 24 in response to the imaging command in such a manner that the head 8a of the subject 8 is imaged. The receiving coil 4 receives an MR signal from the subject 8 therein. The MR signal received by the receiving coil 4 is transmitted to the reconstruction unit 52 of the controller 5, where an image of the head 8a of the subject 8 is reconstructed.

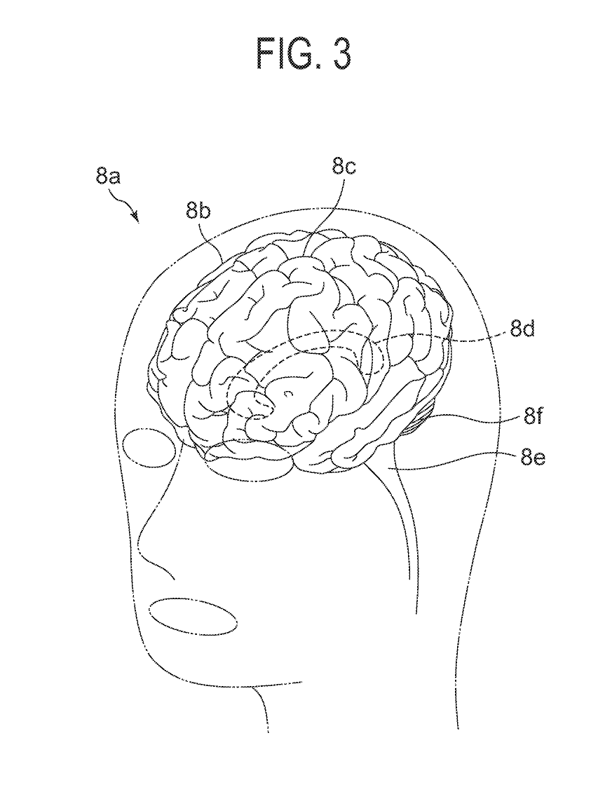

FIG. 3 is a diagram schematically showing a reconstructed three-dimensional image DV of subject's head 8a.

The three-dimensional image DV includes data about a brain 8b, a corpus callosum 8d, a brain stem 8e and a cerebellum 8f, etc. After the reconstruction of the image, the operation flow proceeds to Step S2.

At Step S2, the median plane determination unit 53 determines a median plane with respect to the three-dimensional image DV. In the first embodiment, a sagittal section that passes through a longitudinal fissure of cerebrum 8c of the brain 8b is defined as the median plane. Thus, the median plane determination unit 53 detects the longitudinal cerebral fissure 8c from within the three-dimensional image DV to determine the median plane. A method for detecting the longitudinal cerebral fissure 8c will be explained in brief below.

The longitudinal cerebral fissure 8c corresponds to a groove-like portion defined between the left brain of the brain and the right brain thereof. When the brain 8b is imaged by the MRI system 1, the intensity of an MR signal at the longitudinal cerebral fissure 8c and the intensity of an MR signal at each of tissues (white matter, gray matter, etc.) of the left and right brains differ from each other. In the first embodiment, the longitudinal cerebral fissure 8c is detected by paying attention to the difference in intensity between the MR signals. When the brain is imaged with T1 enhancement, the signal intensity of the longitudinal cerebral fissure 8c becomes a minimum within the signal intensities of the respective portions of the brain. Thus, if it is possible to find out a location where the signal intensity becomes small in the brain, the longitudinal cerebral fissure 8c can be detected, thereby making it possible to determine a median plane.

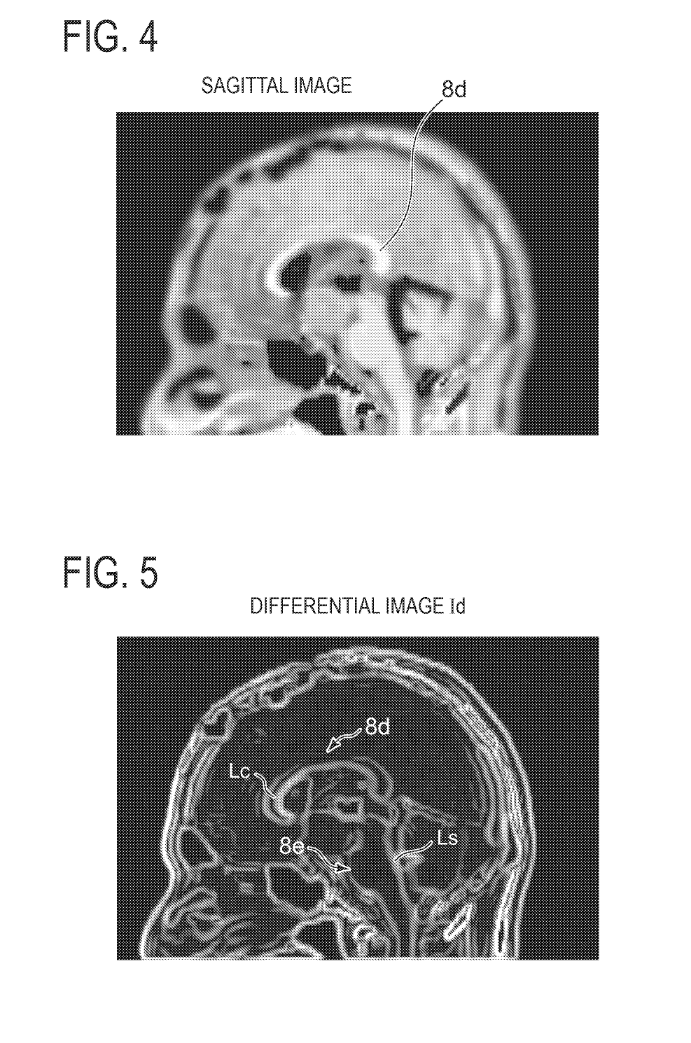

FIG. 4 is a sagittal image of the head 8a at its median plane.

The brain 8b, corpus callosum 8d and brain stem 8e, etc. are contained in a section thereof at its median plane. After the median plane has been determined, the operation flow proceeds to Step S3.

At Step S3, the contour enhancement unit 54 (see FIG. 1) executes a process for enhancing the contours of the corpus callosum 8d and brain stem 8e of the sagittal image shown in FIG. 4.

FIG. 5 is one example showing an image in which the contours of the corpus callosum 8d and brain stem 8e have been enhanced.

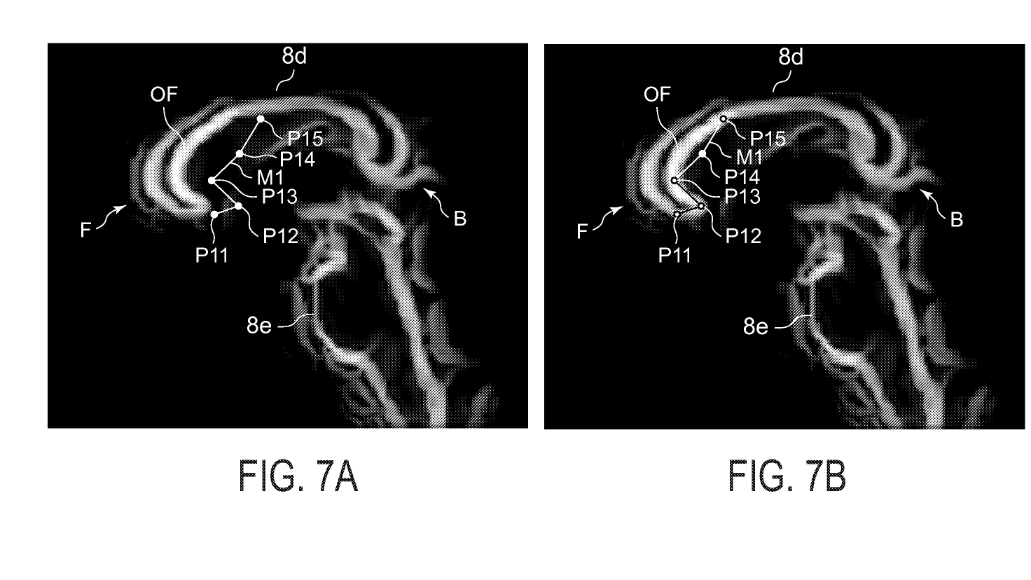

In the first embodiment, a process for modeling part of the contour of the corpus callosum 8d and part of the contour of the brain stem 8e is performed at Step S4 to be described later (see FIGS. 7 through 9). Therefore, the process of enhancing the contour Lc of the corpus callosum 8d and the contour Ls of the brain stem 8e is performed at Step S3 as its preprocess. In the first embodiment, a differential image Id of the sagittal image (see FIG. 4) is formed to thereby enhance the contour Lc of the corpus callosum 8d and the contour Ls of the brain stem 8e (see FIG. 5). In the differential image Id, each region suddenly changed in the value of the MR signal is visualized emphatically. Since the contour Lc of the corpus callosum 8d and the contour Ls of the brain stem 8e suddenly change in signal value, the contour Lc of the corpus callosum 8d and the contour Ls of the brain stem 8e are represented emphatically. It is understood in FIG. 5 that the contour Lc of the corpus callosum 8d and the contour Ls of the brain stem 8e are represented white and enhanced. After the enhancement of their contours, the operation flow proceeds to Step S4.

At Step S4, the modeling unit 55 models M1 using the three contour models. These three contour models will be explained below.

FIGS. 6A, 6B, and 6C are diagrams schematically showing the three contour models.

FIG. 6A is a contour model M1 for modeling an outline OF of a front end F of a corpus callosum 8d. FIG. 6B is a contour model M2 for modeling an outline OT of a caudal end B of the corpus callosum 8d. FIG. 6C is a contour model M3 for modeling an outline OP of an upper portion U of a brain stem 8e. The three contour models M1, M2 and M3 are models represented by points and curve lines. The contour model M1 is represented by five points P11 through P15 and four curve lines L11 through L14. The contour model M2 is represented by five points P21 through P25 and four curve lines L21 through L24. The contour model M3 is represented by five points P31 through P35 and four curve lines L31 through L34. The contour models M1, M2 and M3 are stored in the storage unit 56.

A procedure for modeling the outline OF of the front end F of the corpus callosum 8d, the outline OT of the caudal end B of the corpus callosum 8d and the outline OP of the upper portion U of the brain stem 8e will be described below.

The modeling unit 55 (see FIG. 1) reads the contour model M1 from the storage unit 56 and performs affine transformation for positioning the contour model M1 with respect to the outline OF of the front end F of the corpus callosum 8d in the differential image Id.

FIG. 7A is a diagram showing the manner of the contour model M1 prior to affine transformation thereof on the corpus callosum 8d of the differential image Id, and FIG. 7B is a diagram showing the manner of the contour model M1 subsequent to affine transformation thereof on the corpus callosum 8d of the differential image Id, respectively.

Incidentally, the corpus callosum 8d of the differential image Id is shown in diagrams for convenience of explanation in each of FIGS. 7A and 7B.

The modeling unit 55 aligns the contour model M1 with the outline OF of the front end F of the corpus callosum in the differential image Id by affine transformation. It is understood that when FIGS. 7A and 7B are compared, the contour model M1 is brought into registration with the outline OF of the front end F of the corpus callosum 8d by affine transformation.

Since, however, there are differences between individuals in the shape of the corpus callosum 8d, the affine transformation of the contour model M1 alone may not model the outline OF of the front end F of the corpus callosum 8d with a sufficient degree of accuracy. In the first embodiment, the contour model M1 subsequent to its affine transformation is therefore deformed based on the front end F of the corpus callosum 8d. In order to perform its deformation, the modeling unit 55 deforms the contour model M1 subsequent to its affine transformation, based on the front end F of the corpus callosum 8d.

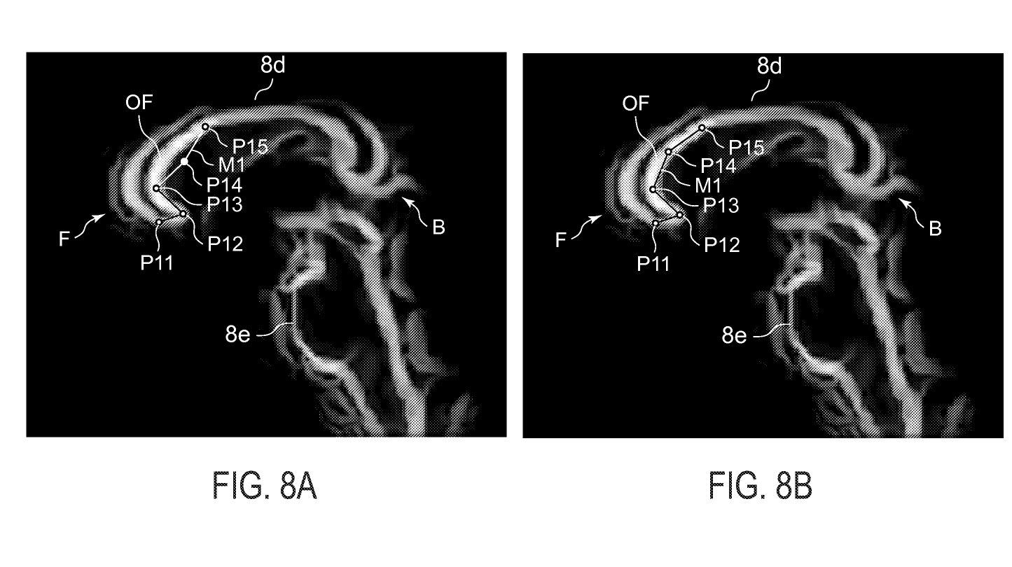

FIG. 8A is a diagram showing the manner of the contour model M1 subsequent to its affine transformation, prior to its deformation based on the front end F of the corpus callosum 8d, and FIG. 8B is a diagram showing the manner thereof subsequent to its deformation based on the front end F of the corpus callosum 8d, respectively.

It is understood from FIGS. 8A and 8B that the contour model M1 is fitted to the outline OF of the front end F of the corpus callosum 8d with satisfactory accuracy by deformation processing.

The outline OF of the front end F of the corpus callosum 8d is modeled in the above-described manner.

The outline OT of the caudal end B of the corpus callosum 8d and the outline OP of the upper portion U of the brain stem 8e are also modeled below in the same manner as described above.

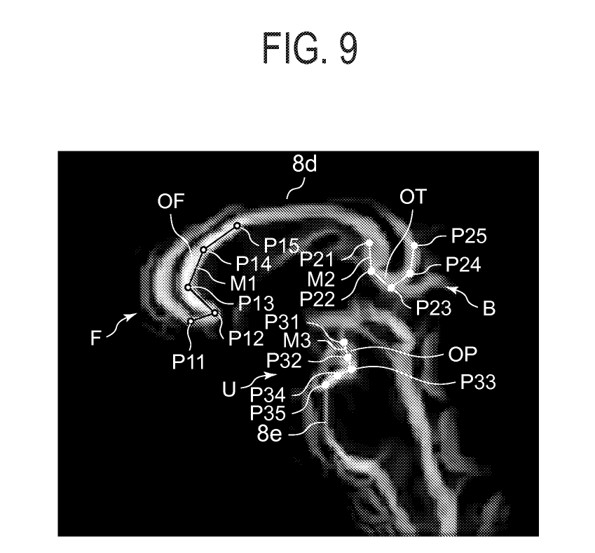

FIG. 9 is a diagram showing the manner of both the corpus callosum 8d and the brain stem 8e after modeling of the outline OT of the caudal end B of the corpus callosum 8d and modeling of the outline OP of the upper portion U of the brain stem 8e are performed.

The outline OT of the caudal end B of the corpus callosum 8d is modeled using the contour model M2, whereas the outline OP of the upper portion U of the brain stem 8e is modeled using the contour model M3.

After their modeling has been performed in this way, the operation flow proceeds to Step S5.

At Step S5, the feature point setting unit 57 (see FIG. 1) determines and sets feature points to the modeled outline OF of the front end F of the corpus callosum 8d, the modeled outline OT of the caudal end B, the modeled outline OP of the brain stem 8e. In the first embodiment, the outline OF of the front end F of the corpus callosum 8d is set with a point P12 of the contour model M1 as a feature point, and the outline OT of the caudal end B of the corpus callosum 8d is set with a point P23 of the contour model M2 as a feature point (see FIG. 9). The outline OP of the brain stem 8e is set with a point P33 of the contour model M3 as a feature point.

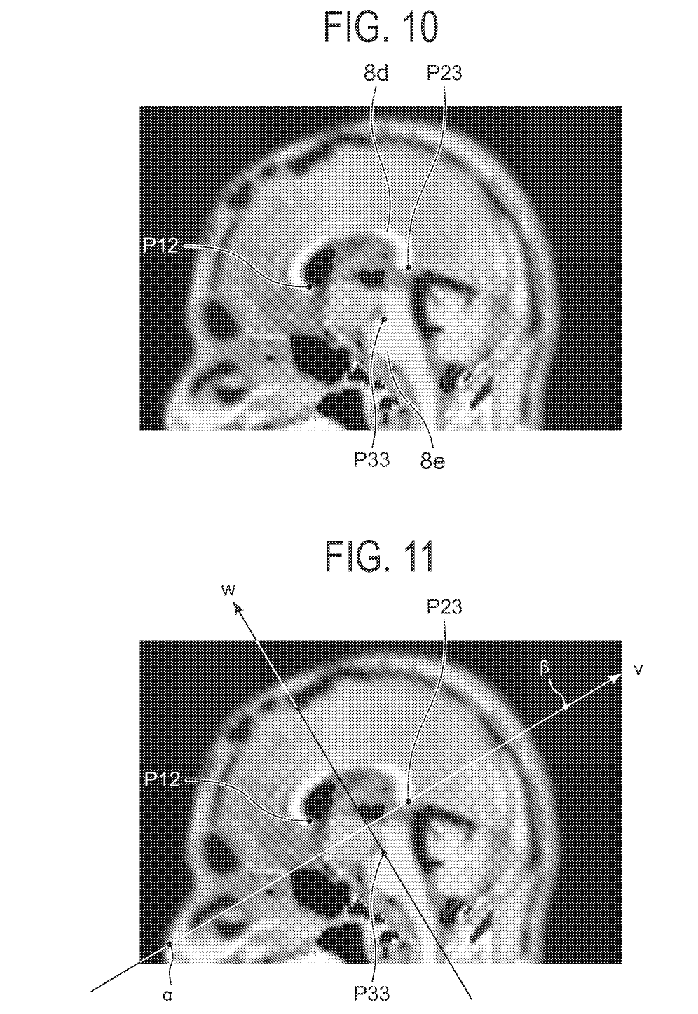

FIG. 10 is a diagram showing the relationship of positions between the sagittal image (see FIG. 4) and the three feature points P12, P23 and P33.

After the three feature points P12, P23 and P33 have been set, the operation flow proceeds to Step S6.

At Step S6, the reference axis setting unit 58 (see FIG. 1) determines and sets reference axes, based on the feature points P12, P23 and P33.

FIG. 11 is a diagram showing one example of the set reference axes.

In the first embodiment, two reference axes V and W orthogonal to each other are set based on the three feature points P12, P23 and P33. The reference axes V and W are regression lines of the three feature points P12, P23 and P33. After the reference axes V and W have been set, the operation flow proceeds to Step S7.

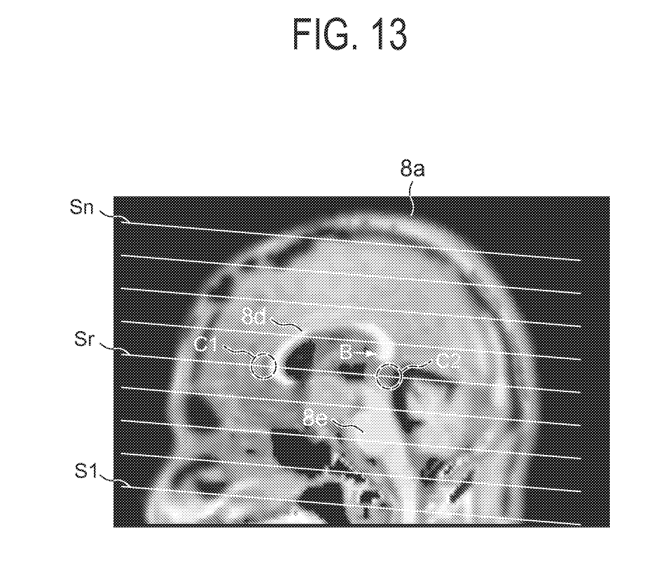

At Step S7, the slice setting unit 59 sets a reference slice Sr being the basis of a plurality of slices S1 through Sn set to the head of the subject within the slices S1 through Sn (see FIG. 13 to be described later). In the first embodiment, the reference slice Sr is set so as to pass through a front bent portion c1 of the corpus callosum 8d and a region c2 interposed between the caudal end B of the corpus callosum 8d and the brain stem 8e. A method for setting the reference slice Sr will be explained below.

FIGS. 12A and 12B are diagrams for describing the reference slice Sr.

FIG. 12A is a diagram for describing a procedure up the setting of the reference slice Sr.

In the first embodiment, a line segment αβ lying on a reference axis V is rotated by a rotational angle Φ=φ1 about the origin O of the reference axes V and W as shown in FIG. 12A. With the rotation of the line segment αβ by the rotational angle φ1, the line segment αβ is shifted to a ling segment α′β′.

Next, the line segment α′β′ is parallel-moved by an offset T=t1.

FIG. 12B is a diagram for describing the offset T=t1.

As shown in FIG. 12B, the offset T=t1 indicates an amount of translation for moving in parallel the line segment α′β′ by v1 along the reference axis V and moving it in parallel by w1 along the reference axis W.

With the movement of the line segment α′β′ by the offset T=t1, points α′ and β′ are moved to their corresponding α″ and β″ (see FIG. 12A). In the first embodiment, a line segment α″β″ is set as the reference slice Sr.

Incidentally, the rotational angle Φ=φ1 and the offset T=t1 have been stored in the storage unit 56 in advance (see FIG. 1). The slice setting unit 59 moves the line segment αβ to the line segment α″β″ in accordance with the rotational angle Φ=φ1 and offset T=t1 stored in the storage unit 56 to thereby set the reference slice Sr. The rotational angle φ1 and the offset T=t1 are values determined in such a manner that the line segment α″β″ passes through the bent portion c1 and the region c2. As a method of determining the rotational angle φ1 and the offset T=t1, there are known, for example, methods (1) and (2) shown below.

(1) The values of a rotational angle φ1 and an offset T=t1 are determined using brain data of a volunteer having a brain of a standard shape. Described concretely, when a line segment αβ is set with respect to the brain having the standard shape and converted to a line segment α″β″, a rotational angle Φ and an offset T necessary to allow the lie segment α″β″ to pass through a bent portion c1 and a region c2 are calculated. The so-calculated values are considered to be adopted as the rotational angle φ1 and the offset t1.

(2) The values of a rotational angle φ1 and an offset t1 are determined using brain data of a plurality of volunteers. Described specifically, when a line segment αβ is set with respect to a brain of each volunteer and converted to a line segment α″β″, a rotational angle Φ and an offset T required to allow the line segment α″β″ to pass through a bent portion c1 and a region c2 are calculated for every volunteer. As to the rotational angles Φ and offsets T calculated every volunteer, the average value of the rotational angles and the average value of the offsets are calculated. The so-calculated average values are respectively considered to be adopted as the rotational angle φ1 and the offset t1.

After the reference slice Sr has been set in the above-described manner, the operation flow proceeds to Step S8.

At Step S8, the slice setting unit 59 (see FIG. 1) sets the remaining slices, based on the reference slice Sr.

FIG. 13 is a diagram showing one example of set slices.

In the first embodiment, n slices S1 through Sn arranged at equal intervals are set based on the reference slice Sr.

After the slices S1 through Sn have been set, the operation flow proceeds to Step S9, where the subject 8 is imaged using an actual scan based on the set slices S1 through Sn.

In the first embodiment, the reference axes V and W are determined based on the feature points P12, P23 and P33 set to the brain 8b of the subject 8, and the line segment αβ lying on the reference axis V is moved in accordance with the rotational angle φ1 and the offset t1 thereby to set the slices S1 through Sn. Accordingly, the slices S1 through Sn are determined on the basis of the feature points P12, P23 and P33 set to the brain 8b of the subject 8. A relative positional relationship between the feature points P12, P23 and P33 does not differ so greatly even in the case of the brain of any individual subject. Thus, the slices S1 through Sn are set on the basis of the feature points P12, P23 and P33, thereby making it possible to set the slices S1 through Sn even to any subject in such a manner that they are not shifted greatly from desired positions.

Incidentally, although the line segment αβ is rotated by the rotational angle φ1 and moved in parallel by the offset t1 to thereby determine the reference slice Sr, the reference slice Sr may be determined by a method other than the rotation and parallel translation of the line segment αβ.

In the first embodiment as well, the part of the contour Lc of the corpus callosum 8d is modeled based on the differential image Id. It may however be practical to multiply the differential image Id by a probabilistic atlas of the corpus callosum 8d thereby to extract only the corpus callosum 8d from the differential image Id and model part of the contour Lc of the corpus callosum 8d based on the extracted corpus callosum 8d. Since the regions other than the corpus callosum 8d can be eliminated by multiplying the differential image Id by the probabilistic atlas of the corpus callosum 8d, the contour models M1 and M2 can easily be brought into registration with the contour of the corpus callosum 8d, and the contour of the corpus callosum 8d can be modeled with a higher degree of accuracy. Due to a similar reason, even when part of the contour of the brain stem 8e is modeled, the differential image Id is multiplied by a probabilistic atlas of the brain stem 8e thereby to extract only the brain stem 8e from the differential image Id, whereby the part of the contour Ls of the brain stem 8e may be modeled based on the extracted brain stem 8e.

### (2) Second Embodiment

Although the slices S1 through Sn have been set based on the three feature points P12, P23 and P33 in the first embodiment, they may be set using other feature points. A second embodiment will explain a method for setting slices using feature points different from those of the first embodiment while referring to FIG. 2 along with FIGS. 14 through 17.

FIGS. 14 through 17 are respectively diagrams for describing the slice setting method according to the second embodiment.

FIG. 14 is a diagram showing feature points P12, P23 and Q1 set in the second embodiment.

In the second embodiment, the three feature points P12, P23 and Q1 are set at Step S5 (see FIG. 2). While the feature points P12 and P23 are identical to the feature points P12 and P23 employed in the first embodiment, the feature point Q1 is different from the first embodiment and defined to a cerebellum 8f. After these feature points P12, P23 and Q1 have been set, the operation flow proceeds to Step S6.

At Step S6, reference axes are set based on the feature points P12, P23 and Q1.

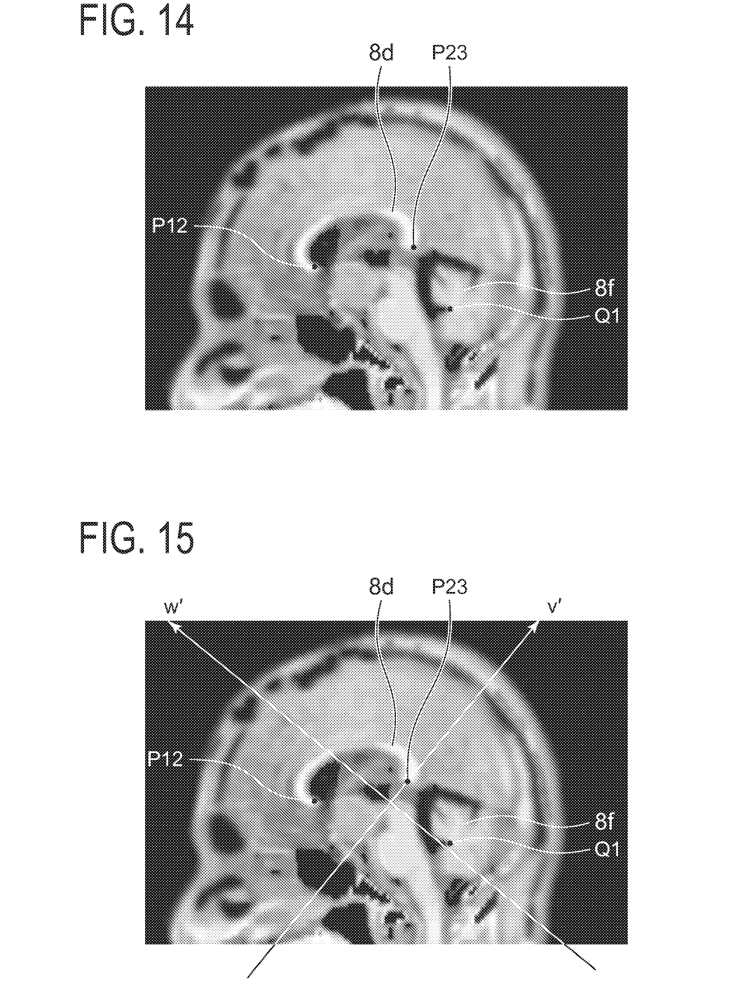

FIG. 15 is a diagram showing one example of set reference axes.

In the second embodiment, two reference axes V′ and W′ orthogonal to each other are set based on the three feature points P12, P23 and Q1. The reference axes V′ and W′ are regression lines of the three feature points P12, P23 and Q1. It is understood that when FIGS. 15 and 11 are compared, the reference axes are set to their corresponding positions different from each other in the first and second embodiments. After the reference axes V′ and W′ have been set, the operation flow proceeds to Step S7.

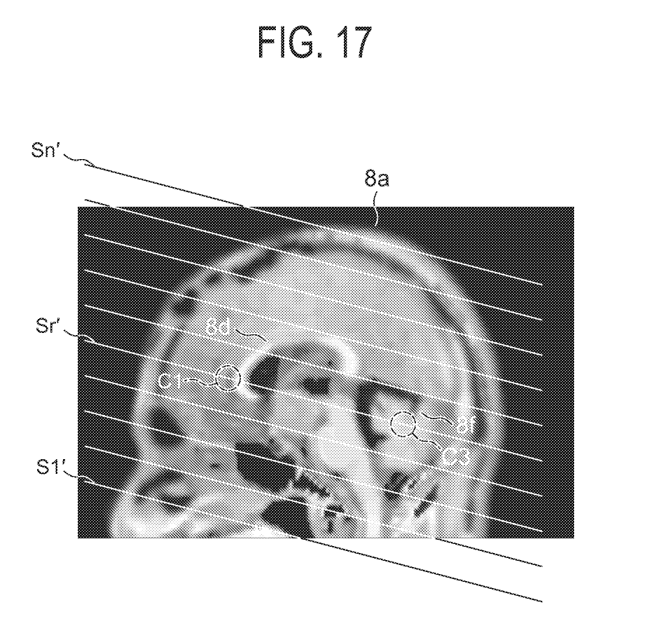

At Step S7, a reference slice Sr′ being the basis of a plurality of slices S1′ through Sn′ (see FIG. 17) set to a head 8a of a subject 8, which lies within the slices S1′ through Sn′, is set. In the second embodiment, the reference slice Sr′ is set so as to pass through a front bent portion c1 of a corpus callosum 8d and a central portion or region c3 of a cerebellum 8f. A method for setting the reference slice Sr′ will be explained below.

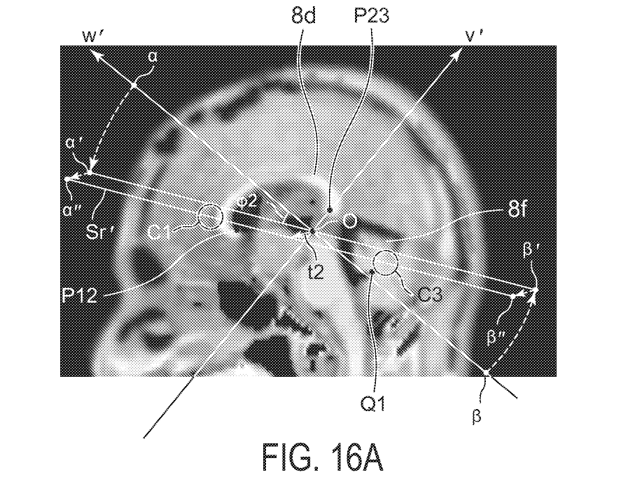

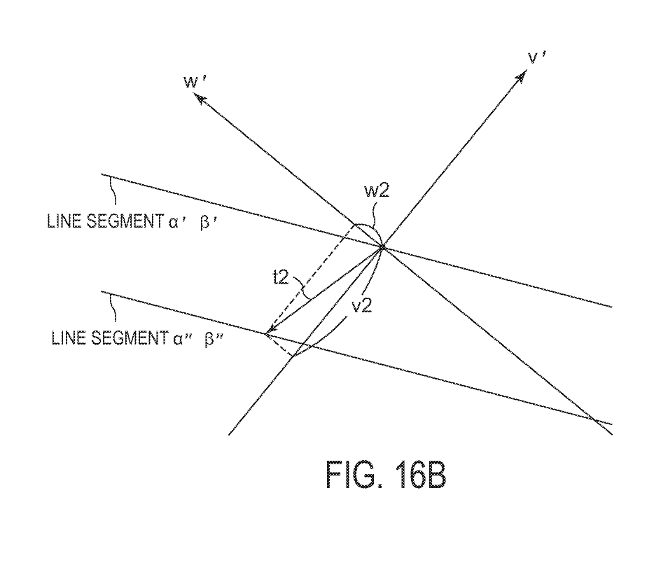

FIGS. 16A and 16B are diagrams for describing the reference slice Sr′.

FIG. 16A is a diagram for describing a procedure up the setting of the reference slice Sr′.

In the second embodiment, a line segment αβ lying on a reference axis W′ is rotated by a rotational angle Φ=φ2 about the origin O of the reference axes V′ and W′ as shown in FIG. 16A. With the rotation of the line segment αβ by the rotational angle φ2, the line segment αβ is shifted to a ling segment α′β′.

Next, the line segment α′β′ is parallel-moved by an offset T=t2.

FIG. 16B is a diagram for describing the offset T=t2.

As shown in FIG. 16B, the offset T=t2 indicates an amount of translation for moving in parallel the line segment α′β′ by v2 along the reference axis V′ and moving it in parallel by w2 along the reference axis W′.

With the movement of the line segment α′β′ by the offset T=t2, points α′ and β′ are moved to their corresponding points α″ and β″ (see FIG. 16A). In the second embodiment, a line segment α″β″ is set as the reference slice Sr′.

Incidentally, the rotational angle Φ=φ2 and the offset T=t2 are values determined using brain data of a volunteer having a standard brain structure anatomically and brain data of a plurality of volunteers in a manner similar to the first embodiment.

After the reference slice Sr′ has been set in the above-described manner, the operation flow proceeds to Step S8, where the remaining slices are set based on the reference slice Sr′.

FIG. 17 is a diagram showing one example of set slices.

In the second embodiment, n slices S1′ through Sn′ arranged at equal intervals are set based on the reference slice Sr′. It is understood that when FIGS. 17 and 13 are compared with each other, the positions where the slices are set are different from one another.

After the slices S1′ through Sn′ have been set, the operation flow proceeds to Step S9, where the subject 8 is imaged based on the set slices S1′ through Sn′.

In the second embodiment, the reference axes V′ and W′ are determined based on the feature points P12, P23 and Q1 set to the brain 8b of the subject 8, and the line segment αβ lying on the reference axis V′ is moved in accordance with the rotational angle φ2 and the offset t2 thereby to set the slices S1′ through Sn′. Accordingly, the slices S1′ through Sn′ are determined on the basis of the feature points P12, P23 and Q1 set to the brain 8b of the subject 8. A relative positional relationship between the feature points P12, P23 and Q1 does not differ so greatly even in the case of the brain of any individual subject. Thus, the slices S1′ through Sn′ are set on the basis of the feature points P12, P23 and Q1, thereby making it possible to set the slices S1′ through Sn′ even to any subject in such a manner that they are prevented from being greatly shifted from desired positions.

Incidentally, the reference slice Sr has been set based on the three feature points P12, p23 and P33 in the first embodiment. In the second embodiment, the reference slice Sr′ has been set based on the three feature points P12, P23 and Q1. The reference slice Sr or Sr′ may however be set selectively set depending on imaging conditions.

Although the reference axes have been set based on the three feature points in the first and second embodiments, the reference axes may be set based on two feature points or may be set based on four or more feature points.

Although the reference axes are of the regression lines of the three feature points in the first and second embodiments, they are not necessarily set to the regression lines.

Many widely different embodiments of the invention may be configured without departing from the spirit and the scope of the present invention. It should be understood that the present invention is not limited to the specific embodiments described in the specification, except as defined in the appended claims.

1. A slice determination apparatus comprising:
a feature point setting unit configured to specify a position of each of a plurality of feature points to a subject;
a reference axis determination unit configured to determine a position of a reference axis, based on the positions of the plurality of feature points; and
a slice setting unit configured to specify a position of each of a plurality of slices, based on the position of the reference axis.

2. The slice determination apparatus according to claim 1, wherein the slice setting unit is configured to specify the position of a first reference slice of the plurality of slices, based on the reference axis and to specify the position of at least a second reference slice, based on the first reference slice.

3. The slice determination apparatus according to claim 1, wherein the slice setting unit is configured to rotate a line segment lying on the reference axis by a predetermined rotational angle and to move the rotated line segment by a predetermined travel distance to specify the position of a reference slice.

4. The slice determination apparatus according to claim 3, further comprising a storage unit configured to store a value of the rotational angle and a value of the travel distance.

5. The slice determination apparatus according to claim 2,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of the first reference slice.

6. The slice determination apparatus according to claim 3,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of a reference slice.

7. The slice determination apparatus according to claim 4,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of a reference slice.

8. The slice determination apparatus according to claim 1, wherein the reference axis is a regression line calculated based on the plurality of feature points.

9. The slice determination apparatus according to claim 2, wherein the reference axis is a regression lines line calculated based on the plurality of feature points.

10. The slice determination apparatus according to claim 3, wherein the reference axis is a regression line calculated based on the plurality of feature points.

11. The slice determination apparatus according to claim 4, wherein the reference axis is a regression line calculated based on the plurality of feature points.

12. The slice determination apparatus according to claim 5, wherein the first reference axis and the second reference axis are regression lines calculated based on the plurality of feature points.

13. A magnetic resonance imaging system comprising:
a slice determination apparatus comprising:
a feature point setting unit configured to specify a position of each of a plurality of feature points to a subject;
a reference axis determination unit configured to determine a position of a reference axis based on the positions of the plurality of feature points; and
a slice setting unit configured to specify a position of each of a plurality of slices based on the position of the reference axis.

14. The magnetic resonance imaging system according to claim 13, wherein the slice setting unit is configured to specify the position of a first reference slice of the plurality of slices, based on the reference axis and to specify the position of at least a second reference slice, based on the first reference slice.

15. The magnetic resonance imaging system according to claim 13, wherein the slice setting unit is configured to rotate a line segment lying on the reference axis by a predetermined rotational angle and to move the rotated line segment by a predetermined travel distance to specify the position of a reference slice.

16. The magnetic resonance imaging system according to claim 15, wherein the slice determination apparatus further comprises a storage unit configured to store a value of the rotational angle and a value of the travel distance.

17. The magnetic resonance imaging system according to claim 14,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of the first reference slice.

18. The magnetic resonance imaging system according to claim 15,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of a reference slice.

19. The magnetic resonance imaging system according to claim 16,
wherein the reference axis determination unit is configured to determine the position of a first reference axis and the position of a second reference axis, based on the positions of the plurality of feature points, and
wherein the slice setting unit is configured to specify a rotational angle of the first reference axis and a travel distance of the first reference axis to specify the position of a reference slice.

20. A slice determining method comprising:
specifying a position of each of a plurality of feature points to a subject;
determining a position of a reference axis, based on the positions of the plurality of feature points; and
specifying a position of each of a plurality of slices, based on the position of the reference axis.
